(19) United States
(12) Patent Application Publication
(10) Pub. No.: US 2026/0209098 A1
(43) Pub. Date: Jul. 23, 2026

(54) SYSTEM FOR DEWATERING AND HYGIENIZATION OF WET WASTE STREAMS

(71) Applicant: CARBON TWELVE AS, Asker (NO)

(72) Inventor: Lars SVENNINGSSON, Träslövsläge (SE)

(21) Appl. No.: 19/142,510

(22) PCT Filed: Dec. 22, 2023
(86) PCT No.: PCT/NO2023/060136

§ 371 Date: Jun. 23, 2025

(30) Foreign Application Priority Data
Dec. 23, 2022 (NO) 20221400

(51) Int. Cl. C02F 11/13; C02F 11/123; C02F 11/126; C02F 11/18

(52) U.S. Cl. CPC C02F 11/13; C02F 11/123; C02F 11/126; C02F 11/185; C02F 2303/04; C02F 2303/10

(57) ABSTRACT

A system and a method for dewatering, sludge drying and hygienization of wet waste streams is provided. The object is achieved using limited power application and recovery. The present invention attains the above-described objective by means for applying localized heating to the wet waste during a drying stage of the wet waste.

### PRIORITY CLAIM AND CROSS-REFERENCE

The present application is a National Stage Application, filed under 35 U.S.C. 371, of International Patent Application No. PCT/NO2023/060136, filed on Dec. 22, 2023, which claims the priority of Norwegian patent application No. 20221400, filed Dec. 23, 2022, each of which is incorporated herein by reference in its entirety.

### BACKGROUND OF THE INVENTION

### Field of the Invention

The invention relates to dewatering in general and more specifically a system for dewatering and hygienization of wet waste streams.

### Background Art

State of the art is reflected in mechanical sludge dewatering such as rotary vacuum-drum dewatering systems where a cylinder covered with a filter cloth picks up sludge from a trough, and wastewater is sucked through the cloth using a lower pressure on the inside of the cylinder, leaving a semi dry cake on the outside, to be scraped off the cloth, before the cloth again is brought into contact with the wastewater.

SE527166 relates to a method for dewatering using heat radiation at a wavelength adapted for high absorption by water molecules. SE528037 and the corresponding international application WO2005118491 relate to a method for concentrating solids in a suspension, such as dewatering sludge, using a semipermeable membrane comprising steel threads together with non steel material or only steel thread weaved in a special pattern having a plurality of horizontal cell layers. Both are by the same inventor as for the present invention.

While known dewatering processes work, there is a desire to reduce power consumption, while increasing dewatering efficiency, and also remove organic compounds in the extracted water, without the use of polymers and/or chemicals.

There is also a desire for hygienization, especially according to EU Council Directive 86/278/EEC with addition of draft directive for advanced hygienization at the priority date of the present application.

WO 9901200 A1, discloses according to the abstract, a continuous vacuum filtering apparatus, with endless belt, for example for filtering, drying and desiccating wastewater sludge in sedimentation tanks or industrial treatment plants, comprising a filtering support or medium arranged in the form of an endless belt wound on two rotating cylinders one of which is coupled with a motor driving it in rotation, the filtering support or medium upper side being arranged between a hopper receiving products to be filtered provided outside the loop constituted by the endless belt and a vacuum vessel provided inside said loop.

U.S. Pat. No. 3,287,819 A, discloses according to the claim, a waste disposal system comprising in combination a continuous filter having an inlet for waste entrained slurry and an outlet for the removal of filtered waste therefrom, a reactor for the combustion of said filtered waste, means conveying filtered waste from said filter to said reactor, means forming part of said filter operative to continuously form a layer of slurry, means directing hot gases exhausting from the reactor to and through said layer thereby removing entrained particles from said gases while the filtered waste is being heated by said hot gases before it is conveyed to the reactor, gas cleaning means, and means directing gases after traversal of said layer of slurry to said gas cleaning means.

KR 101181893B B1, discloses according to the abstract, a filtering apparatus for recycling slurry and resources is provided to simplify the structure of a storing chamber by omitting a drain pump and a motor.

KR 20100053744 A, discloses according to the abstract, a sludge dying device and a method thereof are provided to improve drying efficiency of sludge and to reduce maintenance and repair costs of the sludge by simplifying a drying process without making wet sludge cakes into mixed sludge powder.

KR 20220101359 A, discloses according to the abstract, a prefabricated drum-type wastewater drying device, and more specifically, to a prefabricated drum-type wastewater drying device, wherein when constructing a wastewater drying device using a drum, the number of drums installed in a prefabricated form can be adjusted, so the wastewater treatment capacity is also adjustable, accordingly, compatibility in horizontal and vertical directions is provided to flexibly cope with field conditions such as an installation area and wastewater treatment capacity.

U.S. Pat. No. 4,940,134A discloses according to the abstract, an apparatus for treating a waste solution generated when a photosensitive material is processed by an automatic developing machine includes a waste solution reservoir which is maintained at a constant level. A drum, partially immersed in the waste solution, is rotated to coat its surface. The drum is heated to produce a waste vapor.

There is therefore a need for a method and a system to overcome the above-mentioned problems.

### SUMMARY OF THE INVENTION

### Problems to be Solved by the Invention

Therefore, a main objective of the present invention is to provide an energy efficient system and a method for dewatering and hygienization of wet waste streams.

As used herein, “hygienization” means creating or separating a resultant water volume which is cleaner or more sterile than the original wet waste stream. The cleanliness or sterilization qualities of the resultant water volume may be measured depending on intended use of the resultant water volume using methods known to those of skill in the art. Preferably, the resultant water volume is suitable for effluent release in accordance with applicable wastewater release regulations.

### Means for Solving the Problems

The objective is achieved according to the invention by an apparatus for dewatering and hygienization of wet waste streams as defined in the preamble of claim 1, having the features of the characterising portion of claim 1.

A number of non-exhaustive embodiments, variants or alternatives of the invention are defined by the dependent claims.

The present invention attains the above-described objective by means for applying localized heating to the wet waste during a drying stage of the wet waste.

In a first aspect of the invention, a system for dewatering and hygienization of wet waste streams is provided, comprising a membrane comprising metal threads in an insulating layer, the membrane having a high pressure side for receiving sludge, and a low pressure side for emitting wastewater, further comprising means for applying localized heating to the wet waste during a drying stage of the wet waste. The effect of this is to avoid unnecessary heat loss by heating the cake as it accumulates, but instead just heat the wastewater passing through the membrane. The heating improves the process and contributes to the hygienization.

In one embodiment, the membrane is made of metal. This allows for processing in very rough environments. The metal may be a mesh or solid metals in which pores are made.

In one beneficial embodiment, the localized heating is achieved with electrical power applied to the metal in order to apply localized heating to the wastewater as it passes through the membrane.

In one embodiment, the membrane comprises metal threads in an insulating layer. This allows for a flexible membrane.

In one beneficial embodiment, the localized heating is achieved with electrical power applied to the metal threads in order to apply localized heating to the wastewater as it passes through the membrane. This further improves drying and hygienization, and also enables desalination of salt waste streams while enables improved heat recovery.

In one embodiment, the system further comprises a heating jacket facing the high-pressure side of the membrane. The effect of this is to apply heating by radiation and also reflect back heat radiation. It is preferred to heat the filter before the cake has dried, since there is limited benefit in further heating of dry cake.

In an advantageous embodiment, the system is configured to admit hot air between the membrane and the jacket. This is an alternative method of providing heat for the drying process, and improves the process and contributes to the hygienization.

In one embodiment, the membrane is cylindrical having an axis of symmetry and configured to rotate around the axis of symmetry. The advantage is that the cylinder can be simply constructed with little leaks between the high and low pressure sides, and is suited for the cyclical process of processing wastewater.

In one embodiment, the membrane is arranged as a continuous band. This is an alternative to the above describe cylinder, where the band passes through various stations such as applying, drying and scraping. An advantage is that the various stages can be spatially separated and there is more time for each processing stage, especially the stage where wastewater flows through by gravity before the cake is so thick that pressure difference is required. The processing throughput depends to some extent on the filter surface area, and this scales more easily with a band than, say, a cylinder.

In one embodiment, the membrane is arranged as a fixed filter. In this embodiment, the stages come to the filter, as opposed to the filter passing through the stages. Typically the scrape passes over the filter at the end of each stage.

### Effects of the Invention

The present invention comprises a technological advantage over known systems and methods by use of localized heating of the filter membrane,

The present invention provides several further advantageous effects:
it makes it possible to produce drier filter cake,
it improves the filtering, leaving less waste in the filtered water,
it hygienizes the sludge, and
it saves energy compared to heating the entire filter.

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings.

The invention will be further described below in connection with exemplary embodiments which are schematically shown in the drawings.

FIG. 1 shows a rotary vacuum-drum dewatering system according to prior art.

FIG. 2 shows a dewatering system according to an embodiment of the present invention.

FIG. 3 shows a detail of FIG. 2 with the vacuum-drum.

FIG. 4 shows a cross section of the filtering surface of the vacuum-drum of FIG. 3.

FIG. 5 shows an embodiment where the interior of the vacuum-drum is divided into a plurality of compartments.

### DESCRIPTION OF THE REFERENCE SIGNS

The following reference numbers and signs refer to the drawings:

| | |
|---|---|
| 100 | The dewatering system |
| 100′ | The dewatering system according to prior art |
| 110 | Heat recovery system, heat exchanger |
| 200 | Filter chamber |
| 202 | Inlet |
| 204 | Raw sludge, wet waste streams |
| 206 | Cake |
| 208 | Knife |
| 210 | Trough |
| 212 | Outlet |
| 214 | Water |
| 220 | Heating jacket |
| 300 | Rotating vacuum-drum |
| 320 | Cylindrical surface |
| 330 | Filter membrane |
| 330′ | Secondary filter membrane |
| 332 | Pore within filter membrane |
| 334 | Metal thread |
| 340 | Support member |
| 342 | Mesh opening |
| 350 | Interior of vacuum-drum |
| 352 | Compartment |
| 354 | Steam |
| 356 | Segment heating element |
| 360 | Condensation system |

### DETAILED DESCRIPTION OF THE INVENTION

Various aspects of the disclosure are described more fully hereinafter with reference to the accompanying drawings. It should be understood that any aspect of the disclosure disclosed herein may be embodied by one or more elements of a claim.

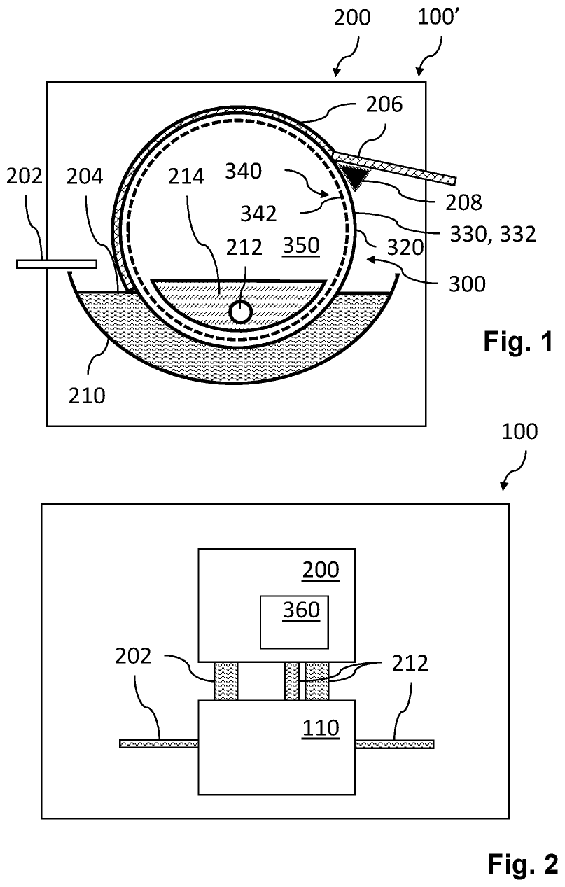

FIG. 1 shows a dewatering system 100′ according to prior art. The system comprises a filter chamber 200 that comprises an inlet 202 that brings raw sludge 204 to a trough 210. A rotating vacuum-drum 300 comprising a cylindrical surface 320 is positioned into the trough in such a way that parts of the cylindrical surface 320 is submerged in the raw sludge. The cylindrical surface 320 comprises a cloth or filter membrane 330 being permeable for water but not the sludge. Typically, this is achieved by the filter membrane comprising numerous pores 332 having a diameter of the order of microns. The filter membrane is mechanically supported by a support member 340, typically a stainless-steel mesh with openings 342 that permits liquid to flow through and into the interior 350 of the vacuum-drum 300. The pore size is adapted to the wastewater to be processed. Typically the range is up to 50 μm, and for sludge water, a range of 5-20 μm has been found to be beneficial.

In use, the rotating vacuum-drum 300 picks up raw sludge 204 while submerged in the sludge in the trough 210. As vacuum is applied to the interior 350 of the drum 300, water is sucked out of the sludge, through the pores 332 of the filter membrane 330 and past the openings 343 of the support member 340, and into the interior 350 of the drum 300. From the interior, the water 214 is brought out through an outlet 212 for further processing. This leaves semi dry sludge, or cake, 206 on the filter membrane, which is dried until it reaches a scrape or knife 208 that removes dried cake from the membrane filter, before the membrane filter once more is rotated into the trough to repeat the cycle.

The invention will be further described in connection with exemplary embodiments which are schematically shown in the drawings.

### Principles Forming the Basis of the Invention

The underlying principle of the invention is the understanding of the thermal energy budget and the optimal use and recovery of the energy.

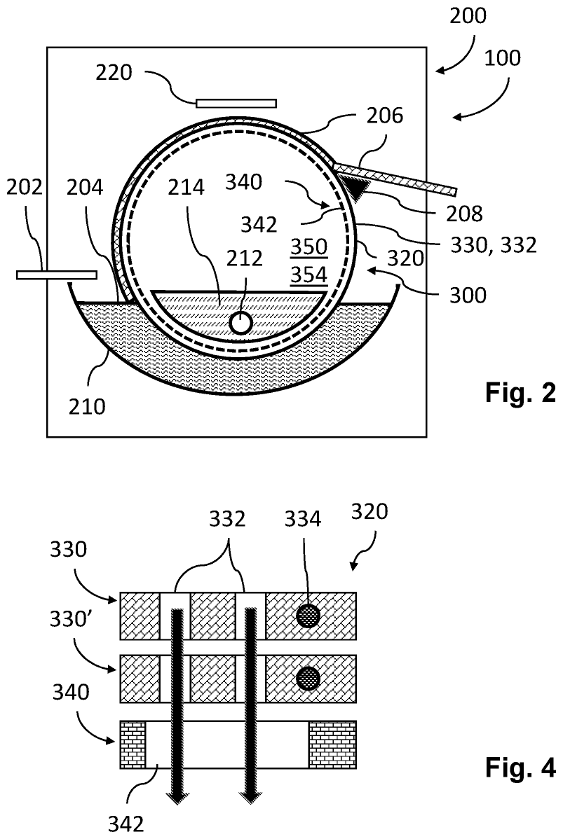

FIG. 2 shows a dewatering system according to an embodiment of the present invention, wherein the system 100 comprises a filter chamber 200 that comprises an inlet 202 that brings raw sludge 204 to a trough 210.

FIG. 3 shows the filter chamber 200 with a rotating vacuum-drum 300 comprising a cylindrical surface 320 is positioned into the trough in such a way that parts of the cylindrical surface 320 is submerged in the raw sludge.

FIG. 4 shows a cross section of the filtering surface of the vacuum-drum of FIG. 3. The cylindrical surface 320 comprises a cloth or filter membrane 330 being permeable for water but not the sludge. Typically, this is achieved by the filter membrane comprising numerous pores 332 having a diameter of the order of microns. The filter membrane 330 is mechanically supported by a support member 340, typically a stainless steel mesh with openings 342 that permits liquid to flow through and into the interior 350 of the vacuum-drum 300.

The membrane can be made entirely of metal. It can also be a composite of a matric reinforced with metal thread. Typically, the matric is insulating. Typically, the metal thread is stainless steel. The choice of material is chosen to be compatible with the type of chemicals/wastewater content to be processed.

The filter membrane is heated in order to improve drying of the cake and also effectively turning the holes in the membrane into ejectors that turns the water into steam 354 in the evacuated interior 350 of the vacuum drum 300. The heating may be performed by the mechanical support which, for instance by electrical heating.

In use, the rotating vacuum-drum 300 picks up raw sludge 204 while submerged in the sludge in the trough 210. As vacuum is applied to the interior 350 of the drum 300, water is sucked out of the sludge, through the pores 332 of the filter membrane 330 and past the openings 343 of the support member 340, and into the interior 350 of the drum 300. From the interior, the water 214 is brought out through an outlet 212 for further processing. This leaves semi dry sludge, or cake, 206 on the filter membrane, which is dried until it reaches a scrape or knife 208 that removes dried cake from the membrane filter, before the membrane filter once more is rotated into the trough to repeat the cycle.

Typically, the steam 354 comprises more than water steam. When processing sewage or other organic waste, there is also some ammonia dissolved. The inventor has realised that the system can be adapted for vacuum distillation of ammonia. The heat recovered can be used to pre-heat the raw sludge 204 in a condensation system 360 within the interior 350 of the vacuum-drum 300. Thus, water and ammonia can be separated, leaving cleaner water 214 while recovering a valuable source of nitrogen.

It is desirable to keep the energy consumption to a minimum. The inventor has realised energy can be saved by dividing the vacuum-drum 300 into a plurality of compartments 352. This allows adapting the dewatering process to the position of the filter membrane in the dewatering cycle.

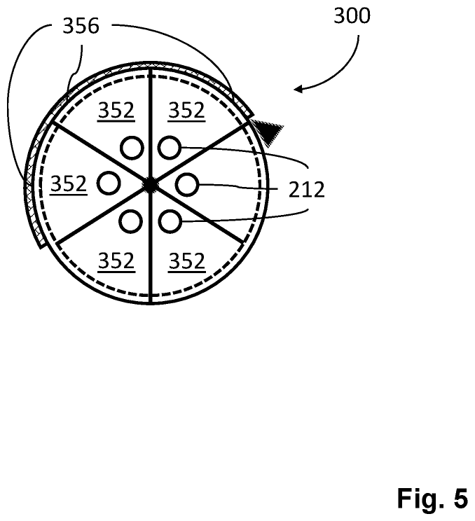

FIG. 5 shows an embodiment where the interior 350 of the vacuum-drum 300 is divided into a plurality of compartments 352. Each compartment forms a segment comprising a segment heating element 356 separately switchable connected to power.

The cycle starts when a lower compartment is fully submerged in the trough. In this position the water is pressed through the filter membrane by the hydrostatic pressure of the sludge level in the trough. The heating element is not powered since most of the heat would be lost to the trough. Therefore, the system operates similarly as known art for this position, and water is extracted from the segment by normal means. Since the steam formation is limited, any partial distillation of ammonia or similar compounds is limited.

As the segment is rotated out of the trough, the heating element is turned on, and steam formation and distillation process starts. Most of the heat is used to form steam and also dry the cake. This process continues until the segment reaches the scraper, at which point power is disconnected. Cake is scraped off and the system prevents the filtering membrane from overheating.

The now unheated segment rotates further until it again reaches the trough, and the process starts over.

### BEST MODES OF CARRYING OUT THE INVENTION

The embodiment of the apparatus according to the invention shown in FIG. 2 comprises the rotating vacuum-drum 300 with a heat recovery system to preheat the wet waste stream.

### Alternative Embodiments

A number of variations on the above can be envisaged. For instance, while the embodiments shown relate to a cylindrical drum, also other forms such as filter bands or fixed filters can be used. Similarly, the heat exchangers used could be replaced by indirect heat exchangers and augmented using heat pumps, while still being within the scope of the invention.

Also, the membrane can be heated externally, as an alternative to localized heating from within the membrane.

With applied heating, and in particular when using electrical heating of the metal threads 334 in the membrane, a significant amount of wastewater is ejected as steam. This can be condensed as freshwater when processing salt wet waste streams such as when processing fish excrements, waste from fish processing and other matter containing salt.

Typically, the heating is performed by the metal threads in the membrane, but also the mechanical support can be used and with electrically heated.

In such two-phase systems, heat recovery can be improved further by first recovering heat from the wastewater and then heat from condensation of steam.

While most of the examples relate to water and water-soluble matter, the invention is not limited to this. It has been found that also oil spill can be cleaned, typically from sea water. In such cases, it has been found particularly beneficial to pre-cover the membrane, particularly with fibrous organic matter, examples of such as peat and saw dust.

While the embodiment of FIG. 5 shows sector-based heating with compartments, it is also possible to perform sector-based heating also without compartments.

While a single membrane is disclosed, it is also possible to use two membranes, as shown in FIG. 4. A secondary filter membrane 330′ is positioned between the filter membrane 330 and the support member 340. Typically, the pores in the secondary filter membrane are smaller than those of the filter membrane. Matter that pass through the first pores but not the second pores, are removed from the volume between the filter membranes (not shown).

A membrane can be a single layer or a compound structure.

### INDUSTRIAL APPLICABILITY

The invention according to the application finds use in wastewater treatment.

1. A system for dewatering and hygienization of wet waste streams, comprising:
a membrane comprising metal, the membrane having
a high-pressure side for receiving sludge, and
a low-pressure side for emitting wastewater,
further comprising means for applying localized heating to the wet waste during a drying stage of the wet waste wherein the localized heating is achieved with electrical power applied to the metal in order to apply localized heating to the wastewater as it passes through the membrane.

2. The system according to claim 1, wherein the membrane comprises metal threads in an insulating layer.

3. The system according to claim 2, wherein the localized heating is achieved with electrical power applied to the metal threads in order to apply localized heating to the wastewater as it passes through the membrane.

4. The system according to claim 1, wherein the system further comprises a heating jacket facing the high-pressure side of the membrane.

5. The system according to claim 4, wherein the system is configured to admit hot air between the membrane and the jacket.

6. The system according to claim 1, wherein the membrane is cylindrical having an axis of symmetry and configured to rotate around the axis of symmetry.

7. The system according to claim 1, wherein the membrane is arranged as a continuous band.

8. The system according to claim 1, wherein the membrane is arranged as a fixed filter.

9. The system according to claim 1, further comprising a heat exchanger for recovering heat from the wastewater to the wet waste stream.
